(19) United States
(12) Patent Application Publication
(10) Pub. No.: US 2010/0309908 A1
(43) Pub. Date: Dec. 9, 2010

(54) METHOD AND SYSTEM FOR COMMUNICATING WITH A NETWORK DEVICE

(75) Inventors: Gregory D. Dolkas, Auburn, CA (US); Mark Gravel, Roseville, CA (US); Bruce LaVigne, Roseville, CA (US)

Correspondence Address: HEWLETT-PACKARD COMPANY;Intellectual Property Administration, 3404 E. Harmony Road, Mail Stop 35, FORT COLLINS, CO, 80528, US

(73) Assignee: HEWLETT-PACKARD DEVELOPMENT COMPANY, L.P., Houston, TX (US)

(21) Appl. No.: 12/480,428

(22) Filed: Jun. 8, 2009

(51) Int. Cl. H04L 12/56

(52) U.S. Cl. 370/389

(57) ABSTRACT

Method for communicating with a network device. A data packet is provided, which includes a header, a payload, and a trailer. The data packet includes an error detection code derived at least partially based on data in the data packet. The error detection code is modified using a reversible function to provide a marked data packet. This marked data packet is sent to the network device.

### BACKGROUND

Communications networks (networks) enable communication between computing devices for forwarding or exchanging data, permitting control of one device by another, or for other purposes. Such networks may be wired and/or wireless, and may be internal (such as a local area network (LAN)) and/or external (such as a wide area network (WAN) or the Internet). Networks can be used to communicate among multiple computing devices. Such communication generally occurs as a result of data that is forwarded among one or more network infrastructure devices (network devices).

Typically, communication within a network takes place via the forwarding of packets from one computing device to a network device, from a network device to another network device, or from a network device to a computing device. For example, by breaking data for information or control into a plurality of packets, forwarding these packets from one computing device or network device to another, and reassembling the packets at a destination computing device, the data can be safely and efficiently communicated.

Security and reliability are important issues for communications networks. One significant issue is the reliability of the network in processing packets and/or forwarding packets. Such reliability is usually dependent on the effectiveness of network devices in processing the packets. A popular troubleshooting tool for network devices is to provide and forward a “test” or “ping” packet into the network. By tracing the path the packet takes as it travels through the network, and the processing of the packet by various network devices, the reliability of the network can be assessed and/or improved.

However, current network troubleshooting tools are becoming less effective as network devices become more intelligent. With network packet forwarding decisions increasingly being made based on the entire packet contents, it is difficult or impossible to predict with confidence where a particular packet will go.

### BRIEF DESCRIPTION OF THE DRAWINGS

FIG. 1 shows a communications network;

FIG. 2 shows an example data packet;

FIG. 3 shows an example method for marking a packet, according to an embodiment of the present invention;

FIG. 4 shows an example method for modifying a cyclic redundancy check (CRC), according to an embodiment of the present invention;

FIG. 5 shows the example data packet of FIG. 2, modified to provide a marked data packet, according to an embodiment of the present invention;

FIG. 6 shows a computer device for marking and sending a data packet;

FIG. 7A shows an example method of receiving a marked packet, according to an embodiment of the present invention;

FIG. 7B shows an example method of receiving a marked packet for a device for a conventional network device;

FIG. 8 shows a network device; and

FIG. 9 shows a method of receiving and modifying a marked data packet.

### DETAILED DESCRIPTION

Network devices forward packets from one device to another device based on an ever-increasing variety of criteria. When troubleshooting a network problem or auditing network operation, it is important to know what path the traffic is taking, and how it is being processed along the way. A problem is that the network equipment, being data-sensitive, may not react to a “test” or “ping” packet in the same way as the real traffic being investigated.

For example, current tracing tools include 802.2 “test” packets (network layer 2) and ICMP “ping” packets (network layer 3), which send and receive information packets containing specific information. Network devices recognize these standard diagnostic packets and process them according to relevant standards. However, these packets are often fundamentally different from “real” network traffic, and therefore are not handled by the network devices in the same way as would occur with the real traffic. Modern network equipment often recognizes application-layer headers and other packet contents for prioritizing, routing, filtering, or other special handling. Special-purpose test packets cannot contain this application-specific data, and thus incorrect or misleading diagnoses may be reported by those tools (and other tools built upon them). Such incorrect diagnoses, for example, may be as inconsequential as a slowing in finding a real fault in a network, or as severe as a failure to identify a critical network security flaw. On the other hand, it may be dangerous to inject a packet, live, into a network because of the concern that the packet may cause harm to a particular device, or to various parts of the network. Thus, it is desirable to check or control a path for a packet, without a risk of doing harm to devices in the network.

Embodiments of the present invention make it possible to inject real traffic into a communications network for tracing and troubleshooting purposes, without adverse effects. Using exemplary methods according to the present invention, the real path a network packet will take can be followed with confidence. Particularly, embodiments of the present invention make it possible to inject a sample of real network traffic by forwarding the packet to a network device and follow it from source to destination, with the assurance that it will not actually get delivered to a non-participating device, or acted upon in a non-transparent or state-altering manner.

Generally, embodiments of the present invention provide, among other things, methods for communicating with a network device in a communications network. For example, such communicating may be used to test a particular network device or group of network devices, or to trace the path of a packet. A data packet is provided, preferably by a computing device. This data packet preferably is a “real” data packet, in that it includes at least a header, a payload, and a trailer. The data packet includes an error detection code, such as but not limited to a cyclic redundancy check (CRC) or an IP checksum, which is derived at least partly based on data in the data packet, such as but not limited to data in the payload or in the header. The error detection code is modified using a reversible function to provide a marked data packet, and the marked data packet is sent to the network device. A reversible function is a function applied to an error detection code that alters the error detection code in some manner that can be consistently undone by another function (a reverse function) to provide the original error detection code; that is, for all valid original error detection codes, the reversible function provides a one-to-one mapping from the original error detection codes to their respective modified error detection codes, and vice versa. This reversible function makes the marked packet identifiable.

The network device, receiving the marked data packet, performs a reverse function to the modified error detection code to undo the reversible function and provide the (original) error detection code. The error detection code is then checked for validity at least partially based on the data in the data packet. If the error detection code is determined to be valid, the packet can be processed.

In this way, a network device that is configured to perform the reverse function can determine that the data packet has been marked, and process the data packet, such as in a manner known in the art. If a receiving network device is not configured to perform the reverse function, its normal validity check of the received data packet, based on the modified error detection code and the payload, will fail. Thus, a network device that is not configured to perform the reverse function will ignore the received data packet, while a network device that is configured to perform the reverse function will preferably record receipt of a marked data packet or other pertinent tracing information and process the packet, and preferably will avoid using the packet to alter network state.

Preferred embodiments will now be discussed with respect to the drawings. The drawings include schematic figures that are not to scale, which will be fully understood by skilled artisans with reference to the accompanying description. Features may be exaggerated for purposes of illustration. From the preferred embodiments, artisans will recognize additional features and broader aspects of the invention.

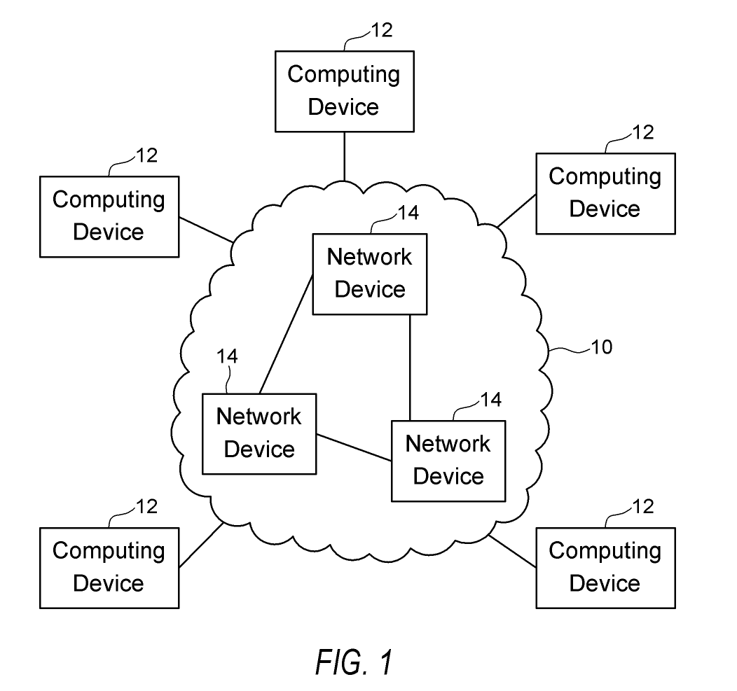

FIG. 1 shows an example communications network 10. A plurality of computing devices 12 communicate with one another via the communications network 10. Examples of communications networks 10 include, but are not limited to, a local area network (LAN), a wide area network (WAN), the Internet, an Intranet, or any combination thereof. The communications network 10 may be open, secure, or partially secure, and may be wired, wireless, or a combination. Examples of computing devices 12 include, but are not limited to, servers, clients, personal computers (PCs), workstations, and peripheral devices such as, but not limited to, printers, facsimile devices, scanners, universal serial bus (USB) linked devices, card devices, Bluetooth devices, and mobile communications devices. Though each of the plurality of computing devices is labeled 12, it will be appreciated that the particular computing devices may vary.

As is understood by one of ordinary skill in the art, data may be exchanged among the computing devices 12 by use of one or more data packets. These packets are forwarded from one computing device 12 to one or more different computing devices via network devices 14 in the communications network 10. Example network devices include, but are not limited to, routers, switches (such as but not limited to Ethernet switches and fiber channel switches), hubs, bridges, gateways, personal computers, workstations, servers, Internet backbones, etc. It will be appreciated that in particular embodiments of the present invention, one or more of the computing devices 12 may also function as a network device or vice versa. It will also be appreciated that the same physical device (with suitable internal communication) or different physical devices (with suitable links) may provide plural network devices and/or computing devices. As a nonlimiting example, one of the computing devices may serve the function of a router within the communications network 10 and in effect be part of the communications network.

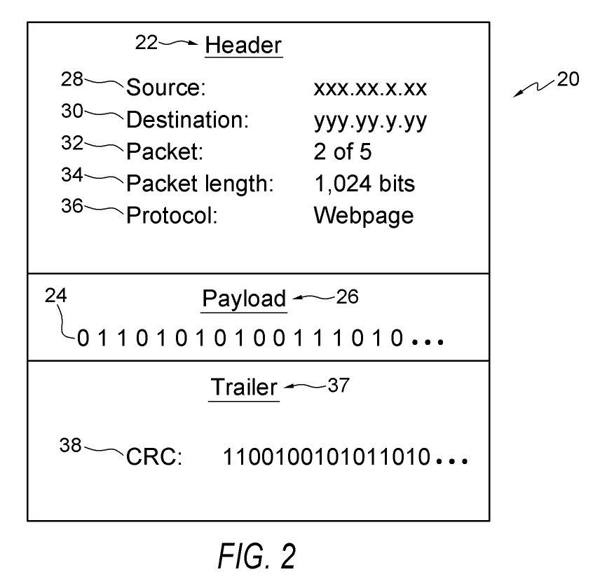

FIG. 2 shows an example data packet 20. As is known in the art, the data packet 20 includes a header 22, which generally provides information for helping the network device 14 process data 24 contained in a payload 26. The example header 22 shown in FIG. 2 includes data such as but not limited to a source internet protocol (IP) address 28, a destination IP address 30, packet sequence information 32, packet length 34, and protocol information 36. Those of ordinary skill in the art will appreciate that the header 22 may contain more or fewer data than those shown in FIG. 2, and that packets may have multiple headers (for example, an Ethernet (Layer 2) header, IP (Layer 3) header, etc.).

The payload 26 includes the data 24, expressed in FIG. 2 as a plurality of bits. The data 24 is not to be limited to any particular type of data. If the packet 20 is a test packet, the data 24 may include information suitable for evaluating the network device 14 or for allowing tracing of the packet. The data may be original data, such as data originally sent from a computing device 12, or may be modified data, such as data modified by a network device 14. Data 24 may include informational data, control data, or any combination thereof.

A trailer 37 preferably includes an error detection code (EDC) (also referred to as a frame check or check code), shown in FIG. 2 as a cyclic redundancy check (CRC) 38. In the example CRC 38 in FIG. 2, the first two bytes of a preferably 32-bit CRC are shown, though an error detection code may have other bit lengths. The error detection code demonstrates to the receiver of the packet that the packet has not been altered or damaged in transit.

The error detection code is based on data in the packet. In a nonlimiting example, the error detection code is determined at least partly based on the payload 26, and may be entirely based on the payload, so that the error detection code may be used to verify that the packet 20 was received correctly by the network device 14. As a more particular example, the error detection code may be based on adding the bits making up the data 24 in the payload 26 and expressing the total in bits to provide the error detection code. If a packet is received with a valid error detection code, it may be accepted by the network device 14. On the other hand, if a received packet contains an invalid error detection code, it may be discarded. Various methods for providing an error detection code are possible, and the present invention is not to be limited to a particular error detection code or a particular method of providing or generating an error detection code. Further, the location of the error detection code in embodiments of the present invention is not limited to the end, or trailer, of the packet, nor is the data from which the error detection code generated limited to data in the trailer of the packet. As another nonlimiting example, the IPv4 header has an EDC, which is an IP header checksum, within the header itself, and this IP header checksum is based on data in the header.

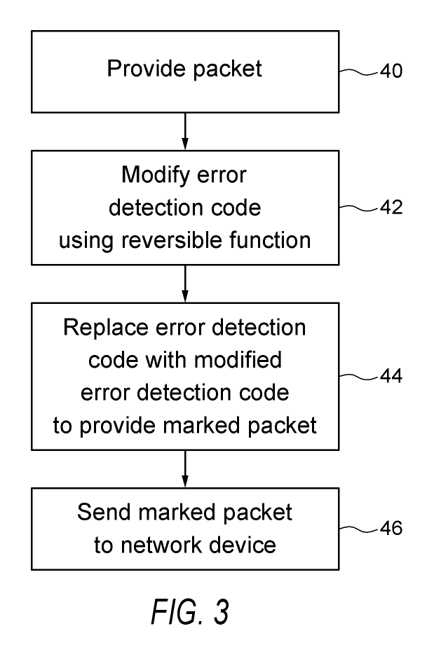

FIG. 3 shows an example method for communicating with a network device including marking a data packet, such as the packet 20. Either a computing device or a network device may be configured to perform the method shown in FIG. 3. In an example method, the packet 20 is provided (step 40), such as by generating the packet, including generating the error detection code, by receiving the packet from another device, such as the computing device 12 or the network device 14, and/or by retrieving a stored packet (such as a preformed packet for testing). If data has not yet been divided into packets, the providing step 40 may perform this function.

The packet 20 is marked by modifying the error detection code using a reversible function (step 42). By using a reversible function, the (properly generated) error detection code, though modified, remains accessible to a properly configured receiving device, such as the network device 14. In this way, the original error detection code may still be used for the purpose of verifying the integrity of the received packet as is known by those of ordinary skill in the art.

The modified error detection code is used to replace the original error detection code in the packet (for example, in the trailer) to provide a marked packet (step 44). FIG. 5 shows a marked data packet 50 based on the packet 20 shown in FIG. 2. In the marked data packet 50, like reference characters are used for like parts as for the packet 20 shown in FIG. 2. However, the marked data packet 50 includes a modified trailer 52, having a modified CRC 54. As shown in the nonlimiting example of FIG. 5, selected bits among the bits in the modified CRC 54 (bit number 4 from each of the two bytes shown) are inverted from the bits in the original CRC 38, thus marking the packet 50, but allowing a network device to recreate the original CRC 38. The marked packet is then sent 42 to a network device (step 46), which may be part of the same device or a different network device or part thereof. As nonlimiting examples, the marked packet may be sent to an external network device or may be sent via internal connection to a different part of the same device (e.g., a marked packet may be injected into the network device's own processing flow).

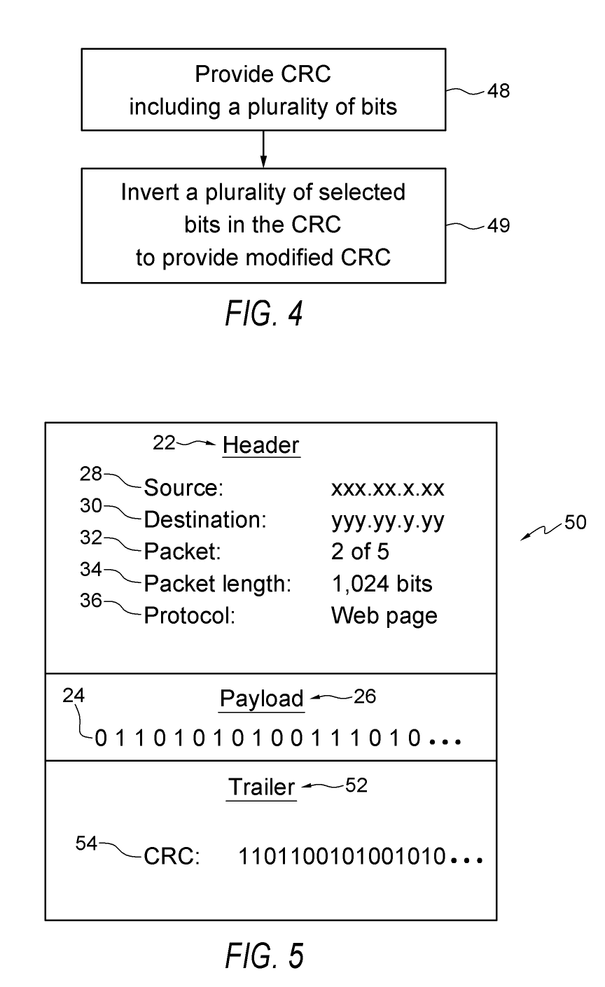

FIG. 4 illustrates an example method of modifying the error detection code, applied herein to a CRC. The CRC is provided (step 48), such as by generating the CRC or retrieving the CRC, and includes a plurality of bits (as shown by example in FIG. 2). Next, the CRC is modified by reversing a plurality of selected bits in the CRC (step 49).

A nonlimiting example modification uses a 1's complement. In other words, all of the 1's bits in the CRC are inverted to 0's, and all 0's bits are inverted to 1's. This provides a one-to-one mapping from the original, valid CRC to the modified CRC.

In another example method, the error detection code (e.g., CRC) is modified by flipping (inverting a “0” to a “1” and a “1” to a “0”) several specifically chosen bits among the bits in the error detection code. In a nonlimiting example, the specific bits chosen are bit number 4 from each of the 4 bytes in a 32-bit CRC. The modified error detection code 54 shown in FIG. 5 is provided according to this example method. This example method is equivalent to performing an exclusive-OR of the CRC with a hexadecimal value 0x10101010. This particular example modification provides the best false acceptance across commonly-used physical layer block encoding schemes. As with the 1's complement above, this method provides a one-to-one mapping from the original, valid error detection code to the modified error detection code. However, this latter example modification is safer than flipping all bits in that it is less likely for a modified packet that gets corrupted in flight to be mistaken for a good, unmodified packet.

The reversible function should be a modification algorithm that provides a one-to-one mapping between the original error detection code and the modified error detection code, and vice versa. However, it will be appreciated that other modifications are possible beyond those described herein and may be equally valid, so long as a function is available to provide the original error detection code from the modified error detection code.

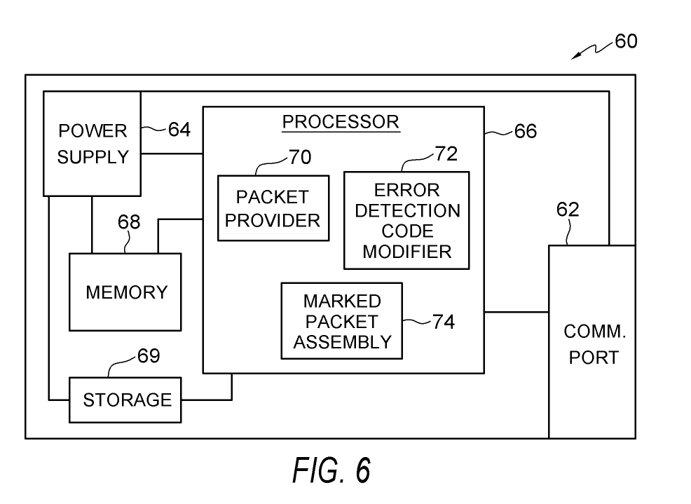

FIG. 6 shows an example computing device 60 for performing the methods shown in FIGS. 3 and 4. The computing device 60 includes one or more communications port(s) 62, which may be any suitable port (including any necessary hardware, software, or firmware) for communicating or interfacing with another device. The communications port(s) 62 should include output capabilities for sending the marked packet 50 (if sent to an external device), and may include input capabilities for receiving packets, controls, or other data. A power supply 64 is provided for powering the computing device 60. For providing and marking a packet before sending, a processor 66 and suitable memory 68 are provided. Storage 69 may be provided for storing packets, instructions, data, or other information or instructions used by the computing device 60.

The processor 66 includes suitable logic for performing methods according to the present invention. As a nonlimiting example, the processor 66 may include logic for providing a packet 70 (e.g., for retrieving a packet from the memory 68, the storage 69, or from the communications port(s) 62, or for generating a packet, including an error detection code). An error detection code modifier 72 modifies the error detection code, such as the CRC, using a reversible function. Once the error detection code is modified, marked packet assembly logic 74 may be provided for replacing the error detection code with the modified error detection code. Note that the logic embodied in the processor 66 may be provided (e.g., installed) by an add-on or external device, via media, by incorporating the method into VLSI of particular hardware, software, or firmware, or in other ways.

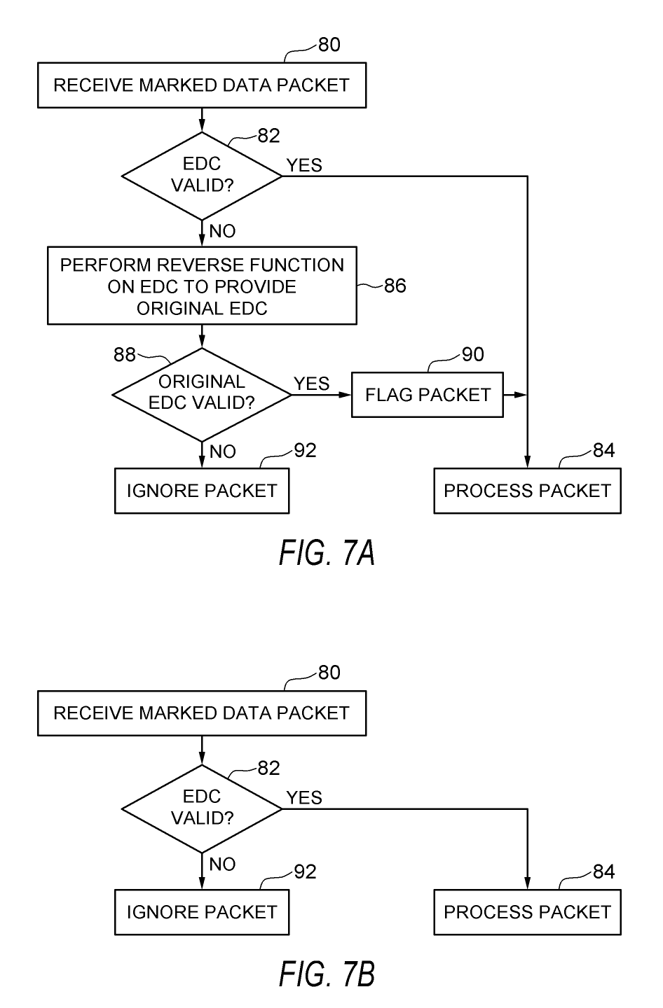

FIG. 7A shows an example method for receiving a packet, including a marked packet, as performed by the network device 14. The network device 14 receives the marked data packet 50 (step 80), such as from the computing device 12. Next, the network device 14 determines if the error detection code (EDC), such as the CRC, is valid at least partly based on the data 24 in the payload 26 (step 82). If the EDC is based on data provided in another part of the packet (such as the header), this data would be used to determine if the EDC is valid. For example, the network device may perform the function used to generate the original EDC to provide a test EDC, and compare this test EDC with the received EDC. If the test EDC and the received EDC match, the packet is valid. In this case, the packet is processed in any appropriate way (step 84), as will be appreciated by those of ordinary skill in the art.

If, on the other hand, the error detection code is not valid, which will occur if the packet is marked according to embodiments of the present invention (and thus the error detection code is actually a modified error detection code), the network device 14 performs a reverse function on the error detection code of the received packet to provide the original error detection code (step 86). As a nonlimiting example, the network device 14 may invert selected bits (e.g., bit number 4 from each of the 4 bytes) of the received EDC, reversing the one-to-one mapping method shown in FIG. 4, and providing the original EDC (if the packet 50 was received correctly). The original error detection code is then tested for validity (step 88), such as by generating a test EDC based on data from the data packet (e.g., in the payload) and comparing the test EDC to the original EDC derived from the received marked data packet 50.

If the original error detection code is valid, it is then determined at least that 1) the packet was received correctly, and 2) the packet is a marked packet. Thus, in an example embodiment, the network device 14 flags the packet as being a marked packet (or trips a counter, or takes other appropriate action) (step 90), and may then process the packet (step 84) as with other (non-marked) packets. One of ordinary skill in the art will appreciate that various methods of processing a packet are available, and may be device-specific. If, however, the test in step 88 for the original EDC fails, this indicates that the packet was not received correctly, and thus the packet is ignored or dropped (step 92).

Because the marked data packet 50 preferably is a real data packet, including a header, payload, and footer, and includes (once restored) an error detection code suitable for packet validation, the packet may be processed similarly to normal network traffic after the processing shown in FIG. 7A. In this way, it can be assured that normal network traffic would respond similarly as with the marked data packets 50, and that information can be gathered based on how the packet is processed under real circumstances. The network device 14, being aware of such packets by being configured for performing methods of the present invention, preferably knows not to do anything with the packet that would alter network state. Suitable software may be provided to trace the packet using the information gathered by the network device 14.

Note that, as shown in FIG. 7B, if a network device 14 is not configured to perform a reverse function on the error detection code according to embodiments of the present invention, or is otherwise not configured to process the packet based on the possibility that a received packet may be a marked packet, the network device will typically ignore the packet after the error detection code fails the initial validity test of step 82. That is, if the validity test of step 82 fails, such a network device may proceed to ignore the packet (step 92), as shown in FIG. 7B. Thus, marking a data packet according to embodiments of the present invention allows such packets to be sent out and processed by intended targets; that is, properly configured network devices 14. This makes it safe to inject arbitrary data into the network 10, without the risk of such data altering the state of any particular network device.

During transit of the test packet 50, data may be collected on the packet, such as by flagging (step 90) and any follow-up data collection. Such data may include, but is not limited to, timing, routing decisions, ports of entry and egress, and packet capture, such as triggering packet sampling tools. With such information, a network management or diagnostic tool can clearly describe the path the marked packet 50 takes, and how it has been processed. For example, in a network security audit application, sample threat packets can be injected into the network 10 and followed to be sure they are handled properly, without worry that they would cause damage. The audit process can be assured that real network traffic will be handled in the same way as the marked data packets 50, and therefore an auditor can know that there is not a hidden security issue. Use of information gathered from processing marked data packets is not to be limited to these examples, however, and it will be appreciated that many different types of analyses may be possible using such information.

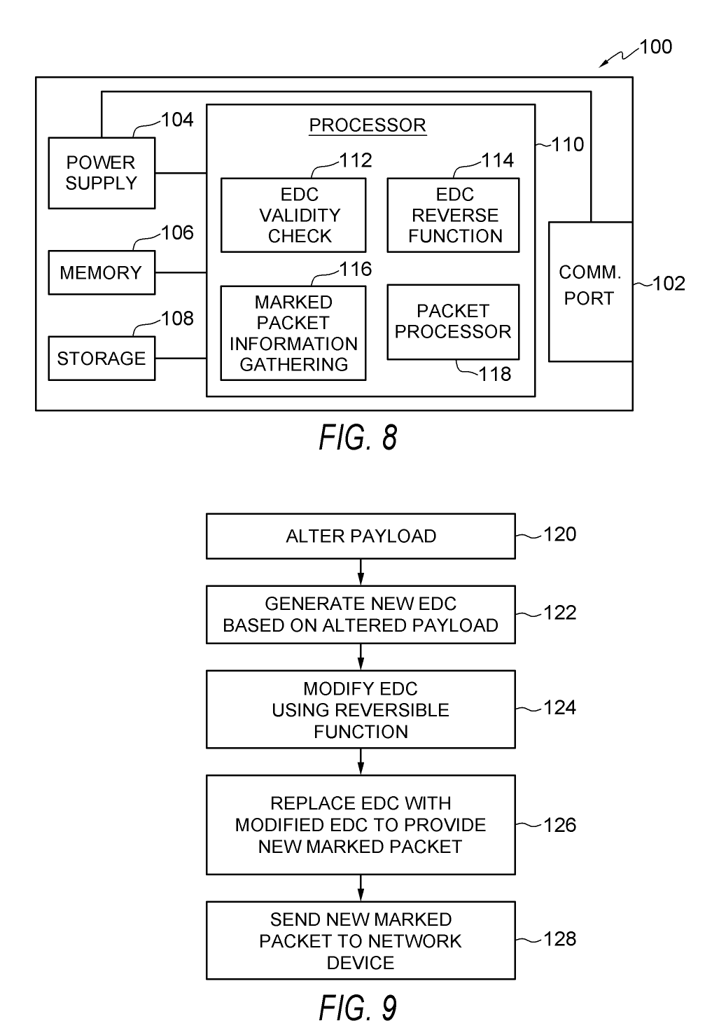

FIG. 8 shows a network device 100 configured to perform the method shown in FIG. 7A. The network device 100 includes one or more communications port(s) 102, preferably having input and output capabilities for receiving and sending packets. A suitable power supply 104, memory 106, and storage 108 are provided, as is a processor 110 having appropriate logic for performing methods of the present invention. As with the computing device 60, logic for the processor 110 may be provided via an add-on or external device, or via machine-readable media. As a nonlimiting example, the processor 110 may include logic 112 for testing validity of an error detection code, reverse function logic 114 for reversing an error detection code to provide an original error detection code, information gathering logic 116 for data related to a marked packet if one is detected, and packet processing logic 118 for processing a packet (preferably whether the packet is marked or normal). The information gathering logic 116 may include, as a nonlimiting example, logic for flagging a received marked packet, logic for determining timing, routing, entry, egress, and/or logic for providing other packet information.

In particular packet-based methods involving networks, a packet may be modified by one or more network devices 14 as the packet travels through the network 10, for any of a variety of reasons. This is especially true if information derived from processing the packet is incorporated into the data in the packet (e.g., in the payload) as the packet goes through the network 10. It will be appreciated that the packet processing logic 118 in the network device 100 may include logic to modify the marked data packet, and generate a new marked data packet. Thus, the logic 118 may include logic similar to that provided in the processor 68 of the computing device 60.

An example method to generate a new marked data packet is shown in FIG. 9. The network device alters 120 the data (e.g., data in the header, payload, and/or trailer) of the received marked data packet, using any suitable method, and generates a new error detection code 122 based on the altered data, where the form and/or packet location of the new error detection code that is generated can be based on the particular data that is altered. This new error detection code is then modified 124 using a reversible function. An example reversible function is an algorithm that inverts selected bits of an error detection code, as described above. The modified error detection code replaces the previous corresponding error detection code in the packet to provide a new marked packet 126, which includes at least the altered data and the modified error detection code. This new marked packet is then sent 128 to a network device (which, again, may include a computing device, including a computing device representing a final destination, and it may be sent to part of the same device or a different network device or part thereof). By employing a consistent error detection code modifying function (algorithm), network devices receiving the new marked packet will be able to determine that the packet is marked and process the packet consistently as the packet travels through the network, even though the data (e.g., data in the payload), and thus the error detection code, changes during transit.

Methods and devices for communicating with a network device, including methods for marking a data packet for a communications network, and for processing a marked data packet, have been shown and described herein having various features and benefits. Because the marked packet contains a modified error detection code that, without performing a reverse function to recover the original error detection code, would be considered invalid by a network device, such a packet will be discarded by any network device that is not configured to perform methods of the present invention. This makes it safe to inject arbitrary data into the communications network 10 via packets. However, because the test packet preferably otherwise contains real data, and because the modified error detection code, once restored to the original error detection code, preserves its packet validation function, the packet can be processed as it would under real circumstances after the reverse function is performed. This gives a network troubleshooter, evaluator, or auditor a highly accurate view of a network's behavior.

Methods and devices of the present invention may be incorporated into other applications, such as but not limited to management troubleshooting and network configuration. One or more devices may be selectively configured to provide or not provide the reverse function necessary to process a marked test packet. This selective configuration may be used to test particular network embodiments. As a nonlimiting example, a test network may be provided using a set of network devices for processing modified error detection codes, providing a “ghost configuration” and the network may be tested using marked data packets. Only the properly configured network devices would process the marked data packets. Once it is determined that the network is properly configured, the injected packets may be set to normal by using the original error detection codes. As disclosed herein, any of the computing devices or network devices may be capable of marking a packet, and thus it is contemplated to send packets that are marked at the beginning of a packet's path, or at one or more locations during packet transit. A network switch could also be configured to provide a new, unmarked data packet by using the original error detection code in the packet in place of the modified error detection code. Thus, embodiments of the present invention may provide a variety of methods for communicating with network devices by determining if and when a particular packet is marked before it is sent.

Devices incorporating embodiments of the present invention can be configured with relatively little effort and expense. Further, such devices can be clearly identified as conforming to embodiments of the present invention. In performing methods according to the present invention, it will be easily ascertainable which devices are capable or incapable of processing test packets, as incapable devices typically will ignore the packets altogether. A sub-network of conforming devices may be provided for communicating data without interference from non-conforming devices.

Methods according to embodiments of the present invention may be provided by hardware, firmware, software, or any combination of the above, so long as the hardware, firmware, software, or combination is configured to perform, or to allow a computing device or network device to perform such methods. Embodiments of the present invention may be embodied in, among other things, computing device-readable instructions in the form of software, firmware, and/or hardware suitable configured to operate on a computing device. Example media embodying the present invention may include, but is not limited to, removable storage, built-in storage, a computer data signal, magnetic, optical, or magneto-optical media, etc. A computing device or network device providing embodiments of the present invention may be any suitably configured computing or network device, and is not to be limited to the configurations shown and described herein. Devices according to the present invention may also include add-on devices, such as add-on processing devices, containing suitable logic for allowing a computing device or network device to perform methods according to the present invention. Computing devices may include network devices configured to perform methods of the present invention, and vice versa. Generally, embodiments of the present invention are not to be limited to a particular configuration of a device or a platform, so long as such embodiments are capable of carrying out one or more methods according to the present invention.

In the foregoing Detailed Description, various features are grouped together in a limited number of embodiments for the purpose of streamlining the disclosure. This method of disclosure is not to be interpreted as reflecting an intention that any claim requires more features than are expressly recited in the claim. Rather, as the following claims reflect, inventive subject matter lies in less than all features of a single disclosed embodiment. Thus, the following claims are hereby incorporated into the Detailed Description, with each claim standing on its own as a separate embodiment of the invention.

While various embodiments of the present invention have been shown and described, it should be understood that other modifications, substitutions, and alternatives are apparent to one of ordinary skill in the art. Such modifications, substitutions, and alternatives can be made without departing from the spirit and scope of the invention, which should be determined from the appended claims.

Various features of the invention are set forth in the appended claims.

What is claimed is:

1. In a communications network, a method of communicating with a network device, the method comprising:
providing a data packet, the data packet comprising a header, a payload, and a trailer, the data packet including an error detection code being derived at least partly based on data in the data packet;
modifying the error detection code using a reversible function to provide a marked data packet;
sending the marked data packet to the network device.

2. The method of claim 1, wherein the network device comprises at least one of a switch and a router; and
wherein the communications network comprises at least one of a local area network (LAN), a wide area network (WAN), and the Internet.

3. The method of claim 1, wherein the data is in the payload; and
wherein the error detection code comprises a cyclic redundancy check (CRC).

4. The method of claim 1, wherein the data is in the header; and
wherein the error detection code comprises an IP header checksum.

5. The method of claim 1, wherein said modifying comprises inverting at least one selected bit in the error detection code.

6. The method of claim 5, wherein said modifying comprises inverting at least one selected bit from each byte in the error detection code.

7. The method of claim 1, further comprising:
receiving, by the network device, the marked data packet;
performing a reverse function to the marked data packet to provide the error detection code;
determining if the error detection code is valid at least partly based on the data in the received packet;
if the error detection code is determined to be valid, processing the packet.

8. The method of claim 7, further comprising:
if the error detection code is determined to be valid, flagging the received packet.

9. The method of claim 8, further comprising:
if the error detection code is determined to be valid, recording at least one of timing information, a routing decision for the received packet, a point of entry for the received packet, a point of egress for the received packet, and a sample of the received packet.

10. The method of claim 7, wherein said processing comprises:
modifying the data in the received packet;
providing a new error detection code based at least partially on the modified data;
modifying the new error detection code using the reversible function to provide a new packet;
sending the new packet to another network device.

11. The method of claim 7, further comprising:
if the error detection code is determined not to be valid, ignoring the received packet.

12. A device comprising suitable logic for performing a method comprising:
providing a data packet, the data packet comprising a header, a payload, and a trailer, the data packet including an error detection code being derived at least partly based on data in the data packet;
modifying the error detection code using a reversible function to provide a marked data packet;
sending the marked data packet to a network device.

13. The device of claim 12, wherein the data is in the payload; and
wherein the error detection code comprises a cyclic redundancy check (CRC).

14. The device of claim 12, wherein the data is in the header; and
wherein the error detection code comprises an IP header checksum.

15. The device of claim 12, wherein said modifying comprises inverting at least one selected bit in the error detection code.

16. A network device including logic for performing a method comprising:
receiving a data packet, the data packet comprising a header, a payload, and a trailer, the data packet including an error detection code that is modified using a reversible function, wherein the error detection code, before being modified, is derived at least partly based on data in the data packet;
performing a reverse function to the received data packet to provide the error detection code;
determining if the error detection code is valid at least partly based on the data in the received data packet;
if the error detection code is determined to be valid, processing the data packet.

17. The network device of claim 16, wherein the method further comprises:
if the error detection code is determined to be valid, flagging the received data packet.

18. The network device of claim 16, wherein the method further comprises:
if the error detection code is determined to be valid, recording at least one of timing information, a routing decision for the received data packet, a point of entry for the received data packet, a point of egress for the received packet, and a sample of the received data packet.

19. The network device of claim 16, wherein said processing comprises:
modifying the data in the received data packet;
providing a new error detection code based at least partially on the modified data;
modifying the new error detection code using the reversible function to provide a new data packet;
sending the new data packet to another network device.

20. The network device of claim 16, wherein the method further comprises:
if the error detection code is determined not to be valid, ignoring the received data packet.

21. A computer-readable medium configured to cause a device to perform the method of claim 1.

22. In a communications network, a method of testing a network device, the method comprising:
for a data packet comprising a header, a payload, and a trailer, generating a cyclic redundancy check (CRC) based on the data packet, the CRC comprising a plurality of bits;
modifying the CRC using a reversible one-to-one function including inverting a plurality of selected bits in the CRC;
storing the modified CRC to provide a marked data packet; and
forwarding the marked data packet to the network device;
wherein the network device receives the marked data packet, reverses the reversible one-to-one function to provide the CRC, and determines if the CRC is valid.
